(19) United States
(12) Patent Application Publication
(10) Pub. No.: US 2004/0111371 A1
(43) Pub. Date: Jun. 10, 2004

(54) Methods and systems for check processing

(76) Inventor: Lawrence J. Friedman, Clifton Park, NY (US)

Correspondence Address: ARLEN L. OLSEN, SCHMEISER, OLSEN & WATTS, 3 LEAR JET LANE, SUITE 201, LATHAM, NY, 12110, US

(21) Appl. No.: 10/442,324

(22) Filed: May 21, 2003

Related U.S. Application Data
(63) Continuation-in-part of application No. 09/927,065, filed on Aug. 9, 2001.

(51) Int. Cl. G06F 17/60

(52) U.S. Cl. 705/42

(57) ABSTRACT

A check processing technique at a point-of-sale uses a check in which a payor signs the check and indicia is automatically printed on the check indicating that the physical check is no longer negotiable. A system may include a point-of-sale terminal or cash register which is connected to a check imager, a MICR (magnetic ink character recognition) reader, and a printer. In one embodiment a method for enabling check processing includes receiving and storing a transaction amount, checking account information from the check, and an electronic image of the check having the payor's signature and indicia automatically printed on the check indicating that the physical check is no longer negotiable. The transaction amount and the checking account information may be forwarded for settlement.

### CROSS-REFERENCE TO RELATED APPLICATION

This application is a continuation-in-part of U.S. patent application Ser. No. 09/927,065 filed Aug. 9, 2001, and, entitled “Methods and Systems for Check Processing Using Blank Checks at a Point-Of-Sale,” the entire subject matter of which is incorporated herein by reference.

### FIELD OF THE INVENTION

The present invention relates generally to the payment for goods or services using checks, and more particularly, the present invention relates to methods and systems for check processing at a point-of-sale.

### BACKGROUND OF THE INVENTION

Checkout at a grocery store often involves payment by a customer using a check. A drawback with customers paying by checks is that it requires the customer to fill out the check, e.g., write out the transaction amount, the payee name, and sign and date the check. Paying by check often slows down the checkout of customers in a checkout lane.

In addition, checks are one of the most expensive tender methods in retail. One of the largest costs involved with tendering payment by checks is bank fees. One way to reduce costs is to utilize an automated clearing house (ACH). The use of ACH in retail stores has been typically confined to stand-aside processing in which the transaction is processed first on a cash register system and then through a separate ACH system at the point-of-sale lane or through a backroom processing where all the checks taken at the cash register are processed using a separate ACH system in a different location after the sales have been concluded, e.g., in an office of the store at the end of the day. While the existing processes reduce bank fees, additional costs are incurred due to increased labor expenses.

Various approaches at checkless transactions have been attempted. For example, U.S. Pat. No. 5,832,463 issued to Funk discloses systems and methods for “checkless” check transactions such as at point-of-sale transactions. In one embodiment, an automated checkless check transaction system includes an input device for receiving checking account information and a check amount of a check drawing on a checking account provided in a transaction. A device is also provided for electronically capturing an image of the face of a completed check including the identification of the payee, the transaction amount, and the account owner's signature. The checking account information, the check amount, and the check image are then transmitted electronically to a checkless transaction system. The paper check may be truncated or marked in some way to indicate that it has been processed and returned to the customer. The checkless transaction system converts the check transaction into an electronic ACH, debit card, or any other suitable transaction where the check amount is electronically presented to the institution drawn on or agent for collection and funding. A separate image database may also be implemented to maintain and store only the captured check images for research purposes.

U.S. Pat. No. 5,053,607 issued to Carlson et al. discloses a check processing device particularly adapted for retailer/customer use at the point-of-sale through use of a MICR (magnetic ink character recognition) read headmeans, means, printer means, and keypad means which feed information into a CPU which communicates, through an existing telecommunication system, with the customer's bank and the retailer's bank in order to transfer funds from the account of the customer to the account of the retailer. The system requires that the customers fill out and sign their checks, endorsement and cancellation data be printed on the checks, and the canceled checks then returned back to the customers.

U.S. Pat. No. 6,164,528 issued to Hills et al. discloses a point-of-sale system designed to read information from a consumer's “blank” check (or written out check), with a subsequent debiting of a consumer's account and crediting a merchant's account for the goods or services provided. The point-of-sale system is designed to read the MICR number from a consumer's “blank” check in order to verify that a consumer has an appropriate balance to conduct the transaction with a given merchant: If the check is approved, a terminal displays a message noting the approval, and the check is returned to the consumer. A printer further makes a paper record of the transaction and the consumer places required information on the paper receipt such as name, street address, city, state, zip code, and telephone number, and signs the receipt expressly authorizing the transaction. Thereafter, the transaction information is transmitted to a central computer system which verifies the consumer's credit worthiness and stores the transaction event information for subsequent bank reconciliation via an ACH or other competing network. The invention eliminates the need for paper checks with all bank reconciliation being accomplished electronically. Additionally, the system allows for the consumer's check to be written on and thereafter voided, canceled, and returned to the consumer.

U.S. Pat. No. 6,257,783 to Hanaoka discloses, not an electronic check cashing process, but a check cashing process which uses paper checks for deposit and settlement. The process includes a customer signing a check. The signed blank check is then inserted into a device for scanning the MICR line for check verification and printing on the check the amount and the store name (payee). The check is inverted and the back of the check is printed with the endorsement information. The check is again inverted and the front of the check is scanned to capture an image of the completed signed check. The resulting image is then sent to the bank where it is stored. The paper check is then used for deposit and settlement.

There is a need for further methods and systems for processing checks at a point-of-sale.

### SUMMARY OF THE INVENTION

In a first aspect, the present invention provides a method for enabling electronic check-processing off a transaction at a point-of-sale. The method includes receiving a transaction amount, receiving checking account information from a physical check, and receiving an electronic image of the physical check with printed first indicia that the physical check is no longer negotiable.

In a second aspect, the present invention provides a method for enabling electronic check processing of a transaction at a point-of-sale. The method includes receiving a transaction amount, receiving a physical check having only a payor's signature, receiving checking account information from the physical check, automatically printing on the physical check a payee, a date, and an amount of the transaction, automatically printing indicia on the physical check indicating that the physical check is no longer negotiable, receiving an electronic image of the physical check with the payor's signature, the payee, the date, the amount of the transaction, and the indicia that the physical check is no longer negotiable, and returning the physical check to the payor.

In a third aspect, the present invention provides a method for electronic check processing. The method includes receiving a transaction amount, receiving checking account information from a physical check, receiving an electronic image of the physical check with printed first indicia that the physical check is no longer negotiable, and forwarding the transaction amount and the checking account information for settlement.

In a fourth aspect, the present invention provides a method for electronic check processing. The method includes receiving a transaction amount, receiving a physical check having only a payor's signature, receiving checking account information from the physical check, automatically printing on the physical check a payee, a date, and an amount of the transaction, automatically printing indicia on the physical check indicating that the physical check is no longer negotiable, receiving an electronic image of the physical check with the payor's signature, the payee, the date, the amount of the transaction, and the indicia that the physical check is no longer negotiable, returning the physical check to the payor, and forwarding the transaction amount and the checking account information for settlement.

In a fifth aspect, the present invention provides a method for warehousing information relating to check transactions. The method includes storing in at least one data storage unit a transaction amount, checking account information from a physical check, and an electronic image of the physical check with printed first indicia that the physical check is no longer negotiable.

In a sixth aspect, the present invention provides a method for electronic check processing. The method includes forwarding an electronic image or a printed copy of a physical check with printed first indicia that the physical check is no longer negotiable for settlement.

In a seventh aspect, the present invention provides a system for enabling electronic check processing at a point-of-sale. The system includes a processor for receiving a transaction amount, checking account information from a physical check, and an electronic image of the physical check having first indicia indicating that the physical check is no longer negotiable, and the processor being operable to at least one of a) transfer the transaction amount, the checking account information and the electronic image to a data storage unit, and b) forward the transaction amount and the checking account information for settlement.

In an eight aspect, the present invention provides a system for enabling electronic check processing at a point-of-sale. The system includes a cash register, a MICR reader, a printer, a scanner, and a processor operable to receive a transaction amount from the cash register, receive checking account information from the MICR reader regarding a physical check, print first indicia on the physical check with the printer indicating that the physical check is no longer negotiable, and receive an electronic image from the scanner of the physical check having the printed indicia.

Other aspects of the present invention include at least one program storage device readable by a machine, tangibly embodying at least one program of instructions executable by the, machine to perform a method for enabling check processing at a point-of-sale, and an article of manufacture comprising at least one computer usable medium having computer readable program code means embodied therein for use in check processing.

### BRIEF DESCRIPTION OF THE DRAWINGS

The subject matter which is regarded as the invention is particularly pointed out and distinctly claimed in the concluding portion of the specification. The invention, however, may best be understood by reference to the following detailed description of various embodiments and the accompanying drawings in which:

FIG. 1 is a block diagram-of (1) one embodiment of a-system for check processing using a blank check at a point-of-sale;

FIG. 2 is a flowchart of one embodiment of a method for check processing using the system of FIG. 1;

FIG. 3 is a flowchart of one embodiment of a batch check posting process using the system of FIG. 1;

FIG. 4 is a block diagram of another embodiment of a system for check processing using a blank check at a point-of-sale;

FIG. 5 is a block diagram of another embodiment of a system for check processing using a blank check at a point-of-sale;

FIG. 6 is a block diagram of another embodiment of a system for check processing using, for example, a partially completed check having at least a payor's signature at a point-of-sale in accordance with the present invention;

FIG. 7 is a flowchart of one embodiment of a method for check processing in accordance with the present invention using the system of FIG. 6;

FIG. 8 is a copy of a partially completed check having at least a payor's signature thereon for use in the system of FIG. 6 and the method of FIG. 7; and

FIG. 9 is a copy of the check of FIG. 8 having the payor's signature and indicia automatically printed at the point-of-sale regarding the transaction and indicating that the physical check is no longer negotiable, an image of which may be captured using the system of FIG, 6 and the method of FIG. 7.

### DETAILED DESCRIPTION OF THE INVENTION

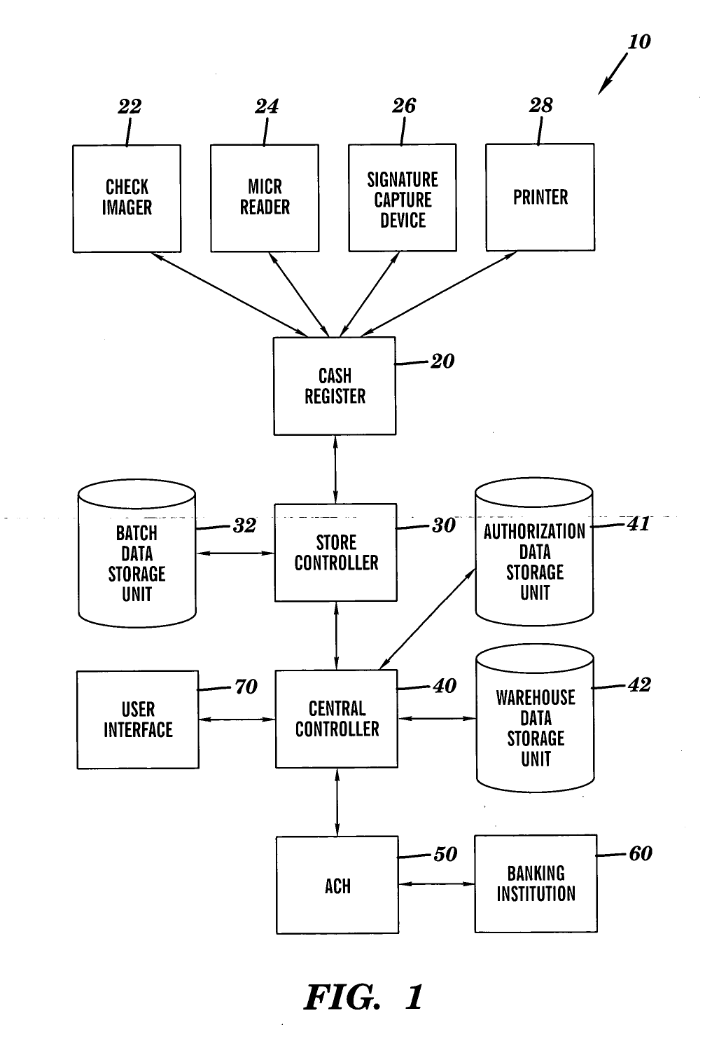

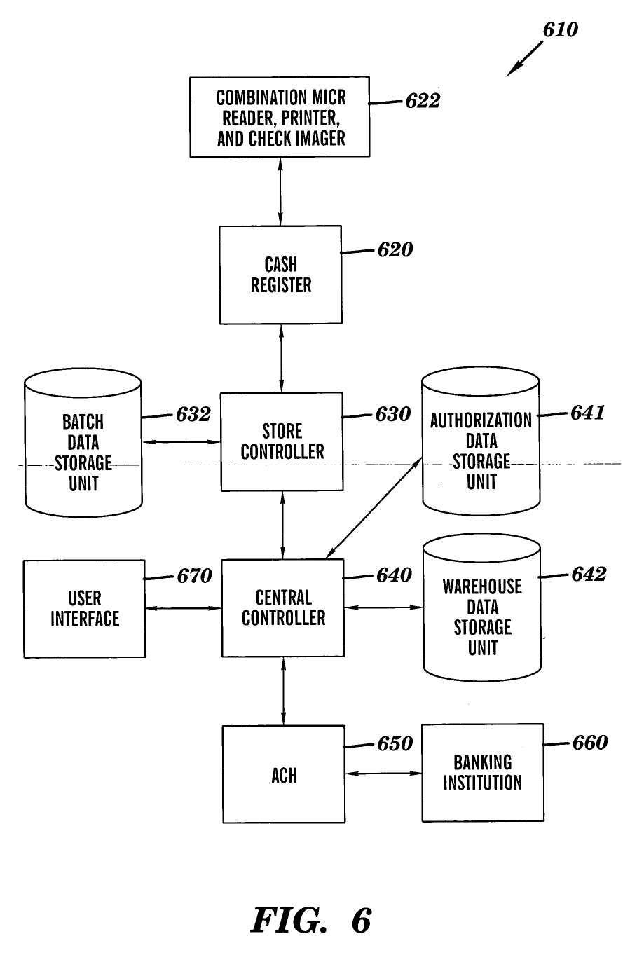

FIGS. 1-5 illustrate check processing techniques using, for example, a blank check. FIGS. 6-9 iustrate check processing techniques in accordance with the present invention using, for example, a partially completed check having at least a customer's, an owner's or a payor's signature thereon and where indicia is automatically printed on a check at the point-of-sale regarding the transaction and indicating that the physical check is no longer negotiable. While the present invention is described in connection with multi-lane retailers such as a retail grocery store, it will be appreciated that the systems and methods of the present invention are suitable for use with other types of operations in which checks are tendered for payment of goods or services.

As explained in greater detail below, the various systems integrate electronic check processing into retail operations and allow customers to pay for goods or services, such as items at a grocery checkout. Allowing a customer to pay with a blank check or a partially completed check reduces the time required for completing the point-of-sale transaction for the customer and for the retailer. In addition, allowing a customer to pay with a blank check or a partially completed check reduces the likelihood of errors and the likelihood of reconciliation adjustments for the customer and the retailer.

Capturing an image of the blank check or the partially completed check having at least the customer's signature thereon and the check having automatically printed indicia indicating that the physical check is no longer negotiable, allows archival and retrieval for use in, for example, proving or collecting payment in the case where the check was drawn on an account with insufficient funds or where the customer tendered the check fraudulently. Capturing an image of the face of a partially completed check having the customer's handwritten signature at the point-of-sale results in two or more items of data for archival and retrieval. In addition, processing the transaction electronically reduces the cost in manually using the check for deposit and settlement.

With reference to FIG. 1, system 10 generally includes a point-of-sale terminal or cash register 20 which is connected to a check imager 22, a MICR (magnetic ink character recognition) reader 24, an electronic signature capture device 26, and a printer 28. Cash register 20 is also operably connected to a local computing unit or store controller 30 which may also be operably connected to a plurality of cash registers (only one of which is shown in FIG. 1), each of which may be located at a respective one of a plurality of checkout lanes via, for example, an in-store local area network. Store controller 30 is also operably connected to a batch data storage unit 32, and to a remote computing unit or central controller 40 which maybe operably connected to a plurality of store controllers (only one of which is shown in FIG. 1), each of which may be located at a respective one of a plurality of stores via, for example, a communication network such as a telephone system, a global communications network such as the Internet, or other suitable communications network. Central controller 40 may be connected to a warehouse data storage unit 42, an authorization data storage unit 41, and to an automated clearing house (ACH) 50 which in turn is operably connectable to one or more banking institutions 60 (only one of which is shown in FIG. 1). It will be appreciated that instead of an ACH, the central controller may be operably connectable to the Federal Reserve, shared bank network, a bank, credit card network, or other suitable means for settlement.

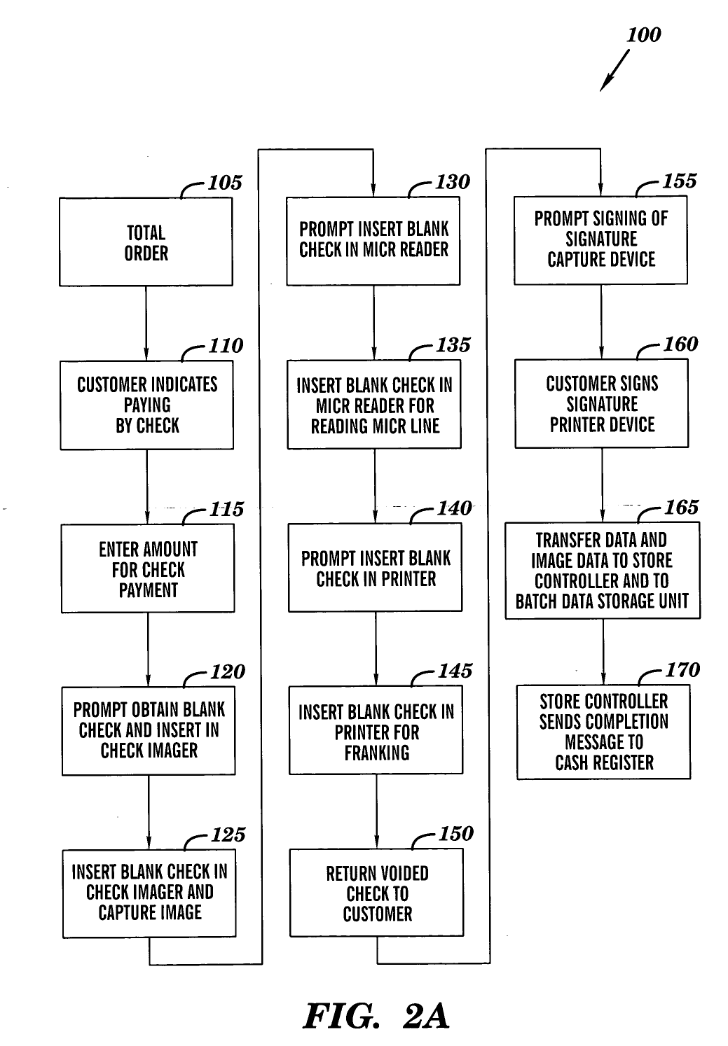

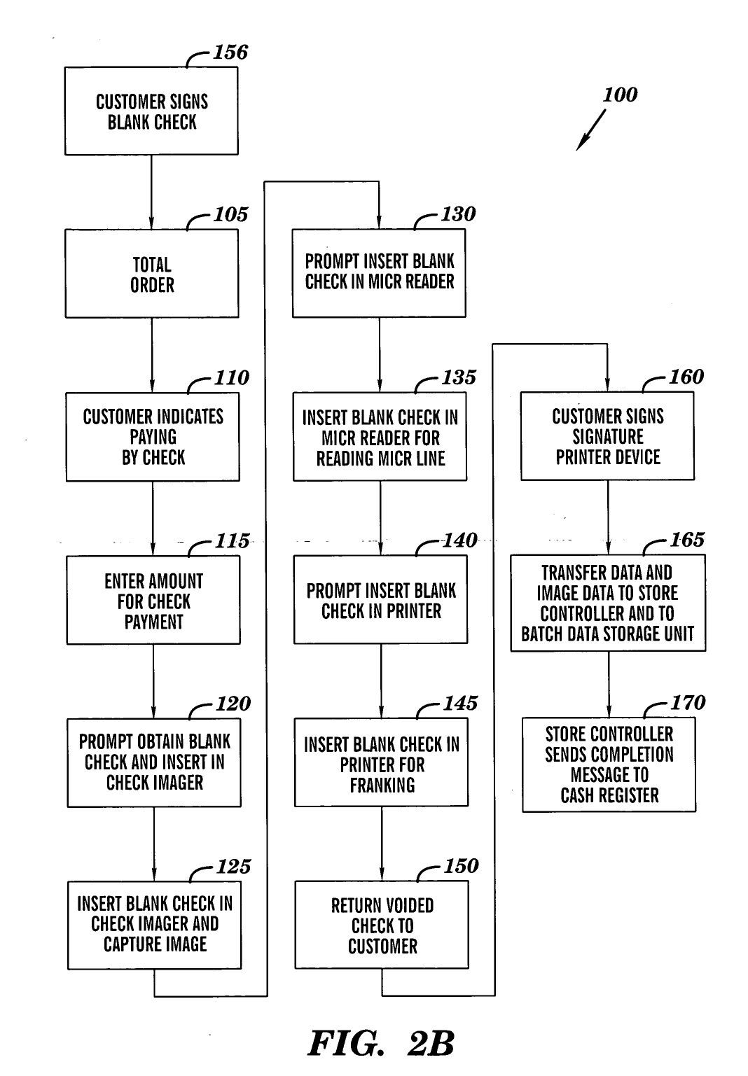

FIG. 2 illustrates a flowchart of one embodiment of a check processing process 100 with a blank check at a point-of-sale using the system shown in FIG. 1. Initially, at 105, the customer's order is totaled on the cash register. If the customer indicates that he or she will be paying by check, at 110, the sales clerk enters the amount of the check payment into the cash register 20 (FIG. 1) at 115. Alternatively, the sales clerk may be required to press a button on the cash register to indicate that payment is by check.

At 120, the cash register terminal prompts the sales clerk to obtain a blank check from the customer and insert the blank check in check imager 22 (FIG. 1). After the sales clerk receives the blank check from the customer, e.g., the customer need not fill in the amount of the transaction, the payee, or sign or date the check, the sales clerk inserts the customer's blank check in the check imager for scanning and obtaining an electronic image of a face of the blank check, at 125.

At 130, the cash register prompts the sales clerk to insert the blank check in MICR reader 24 (FIG. 1). The customer's blank check is inserted in the MICR reader, at 135, for reading and obtaining the routing number, account number, and check number from the MICR line at the bottom of the check.

The cash register then prompts the sales clerk to insert the blank check in printer 28 (FIG. 1), at 145. Inserting the blank check in the printer allows for franking such as printing on the front of the check, for example, “VOID”, ACH required or other required terms and conditions, transaction amount, transaction date, store location, at 145. Thereafter, the sales clerk returns the voided check to the customer, at 150.

At 155, the cash register prompts the sales clerk to instruct the customer to sign signature capture device 26 (FIG. 1). Alternatively, the signature capture device can be configured to prompt the customer, for example, via a display which indicates to the customer the need to sign the signature capture device. In addition, the signature capture device may have a display which displays the check image, the ACH required or other required terms and conditions. It will be appreciated that the customer may be required to sign the signature capture device prior to the sales clerk inserting the blank check into the printer for franking. At 160, the customer signs the signature capture device using a stylus.

At 165, the cash register then transfers the transaction data and image data, e.g., an electronic image of the blank check, electronic image of the customer's handwritten signature, the customer identification, the transaction amount, the transaction date and time, the check number, the MICR code, the store location, lane location identifier, and/or the clerk identifier via store controller 30 (FIG. 1) for storage.

For example, a first generated output may be customer data which is transferred via the store controller and central controller to authorization data storage unit 41 (FIG. 1) for use in determining the check cashing privileges of the customer, as described in greater detail below, and which need not include the image data. For example, the authorization data may include the customer identification, the transaction amount, the transaction date and time, the check number, the MICR code, the store location, lane location identifier, and/or the clerk identifier.

A second generated output may be the transaction data and image data, e.g., an electronic image of the blank check, electronic image of the customer's handwritten signature, the customer identification (e.g., store issued identification card, driver's license, other identification), the transaction amount, the transaction date and time, the check number, the MICR code, the store location, lane location identifier, and/or the clerk identifier, which is transferred via store controller to batch data storage unit 32 (FIG. 1).

After the two outputs are transferred and stored in the data storage units, e.g., on the hard drive of the store controller and/or central controller, the store controller sends a completion message to the cash register indicating the end of the transaction, at 170. Alternatively, the cash register may send the transaction and image data to the store controller and the store controller then generates and forwards the required data to the batch data storage unit and to the authorization data storage unit.

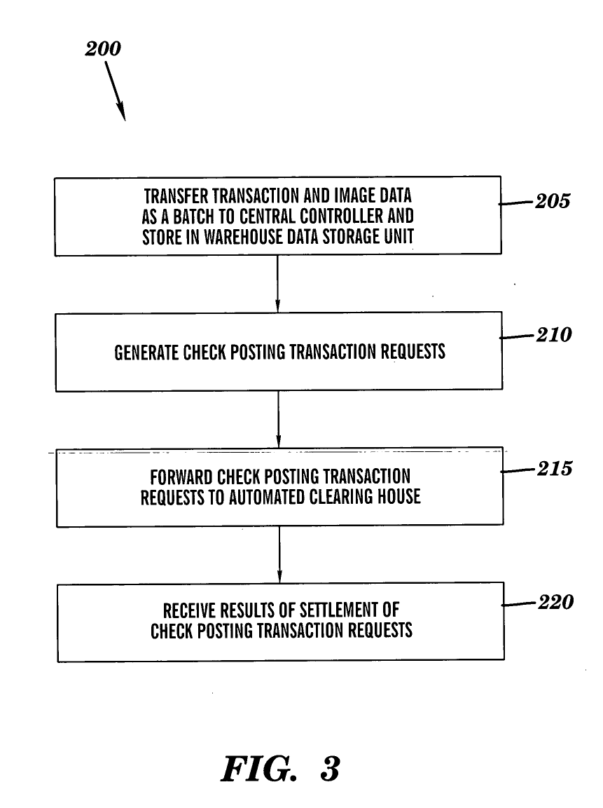

FIG. 3 illustrates one embodiment of a batch check processing. During a scheduled off-peak time each day or other appropriate interval, the transaction and image data that has been stored in the batch data storage unit 32 (FIG. 1) is transferred via store controller 30 (FIG. 1) to central controller 40 (FIG. 1) for storage in warehouse data storage unit 42 (FIG. 1) at 205, which may be owned and maintained by the retailer. The transfer of data may utilize any number of techniques such as FTP or other suitable file transfer protocol. When the data arrives at the warehouse data storage unit, it may be saved in a designated location corresponding to store or site number. The information stored in the warehouse data storage unit, may be accessible via a settlement user interface 70 (FIG. 1) as described below.

Once all the transaction and image data has been collected from the various store controllers for the various stores, a batch process is run by central controller 40 (FIG. 1) on the transaction and image data in the warehouse data storage unit. For example, at 210, a plurality of electronic check posting transaction requests is generated and forwarded, at 215, to ACH 50 (FIG. 1) via FTP or another suitable file transfer protocol or other appropriate electronic transfer method. An electronic check posting transaction may include the transaction amount, the transaction time, the transaction date, the MICR code, the store location identifier, lane location identifier, clerk identifier, and/or customer identifier.

After the ACH process is completed by the ACH, the ACH sends, at 220, an electronic file containing settlement data for each item, e.g., index information and appropriate settlement indicator designating the result of the item's presentation for settlement, to central controller 40 (FIG. 1). This file may be stored in the warehouse data storage unit with the check posting transaction requests and/or indexed for retrieval via settlement user interface 70 (FIG. 1).

If an electronic check posting transaction request presented for settlement is not processable, it may be automatically queued for electronic draft submission. For example, the ACH creates the electronic drafts for those checks queued and presents each to the appropriate institution. Any checks which are not processable and are not cleared by electronic draft are combined with any records that are processed but are declined by the institution (non sufficient funds, closed account, etc.). These records can be sent electronically to the retailer's collection agents for resolution.

With reference again to FIG. 1, user interface 70 may be provided as a query tool designed to assist customer service, check collection and settlement agents in researching and proving transactions. Desirably, the interface is in the form of a point and click interface that allows the user to search for transactions by any of the indexes in the warehouse data storage unit. The interface may combine the transaction information with the check image and signature image into a completed check image. The agent will then be able to view, print or e-mail the completed check image as necessary. Access to this information is desirably read only in that agents will not be able to change transaction information that is stored in the warehouse data storage unit. In the event of fraud, the settlement user interface may allow retrieval of the transaction data, check image, signature image, check posting transaction request, and the settlement data.

The warehouse data storage unit may be owned and maintained by a retailer or by an ACH. Where the warehouse data storage unit is owned by an ACH, data received from the store controller is saved to a designated location, for example, corresponding to the company and store or site number. Once all of the data has been collected from the various store controllers, a batch process may be run on the checks for settlement.

In an alternative embodiment, the system may be configured to provide on-line check posting, e.g., generating electronic check posting transaction requests at the time of the point-of-sale. For example, as described above, store controller 30 (FIG. 1) which stores the transaction and image data in the batch data storage unit may also generate a check posting transaction request by removing the electronic image of the face of the blank check and electronic image of the signature from the transaction and image data. The check posting transaction request may be stored in the batch data storage unit.

The store controller may also forward the check posting transaction request to the central controller. The store controller may also provide a completion message which is sent to the cash register to indicate that the check posting transaction request has been generated. In addition, the store controller may forward a plurality of check posting transaction requests as a batch via a communication network to an ACH for settlement. The output of electronic records produced by the ACH may be reconciled or confirmed with the check posting transaction requests produced by the store controller. In addition, the cash register may be operable for generating a check posting transaction request and operably connected via a communication network for forwarding in real-time the check posting transaction request for settlement.

In another embodiment, the system may include a preauthorization feature for determining a customer's check cashing privileges prior to the customer indicating payment by check, or a check authorization feature where the customer indicates payment by check prior to totaling the items for sale. For example, prior to, during, or after totaling of the customer's grocery items to be purchased, the customer provides identification to the sales clerk such as store issued identification card, a personal identification number, a driver's license, biometric information (as described in greater detail below) or other identification or combinations thereof. The cash register may include a keyboard, a magnetic stripe reader, a bar code reader, etc., for entering the customer's identification. Thereafter, the customer's identification is returned to the customer. Separate devices such a stand alone magnetic card stripe reader or a PIN pad may also be attached to the cash register.

The information regarding the customer's identification may be forwarded via the store controller to the central controller where the information is then used in retrieving, for example, the customer's current check cashing privileges, available limits, number of checks presented during the last week (e.g., checking velocity), etc., from a preauthorization or check authorization data storage such as the authorization data storage unit 41 (FIG. 1) attached to the central controller. Alternatively, the customer's identification information may be forwarded to a local authorization system which is operably connectable to the store controller or to an external host authorization system such as a third-party check authorization system or a third-party check guarantee system for providing the customer's current check cashing privileges, available limits, etc. via a communications network.

The result, e.g., approval or denial of check cashing privileges, of the preauthorization or check authorization process is transferred from the store controller to the cash register and displayed on a display of cash register for observation by the cashier, or the result may be stored and used for determining whether the total of items to be purchased by the customer using a check is permitted.

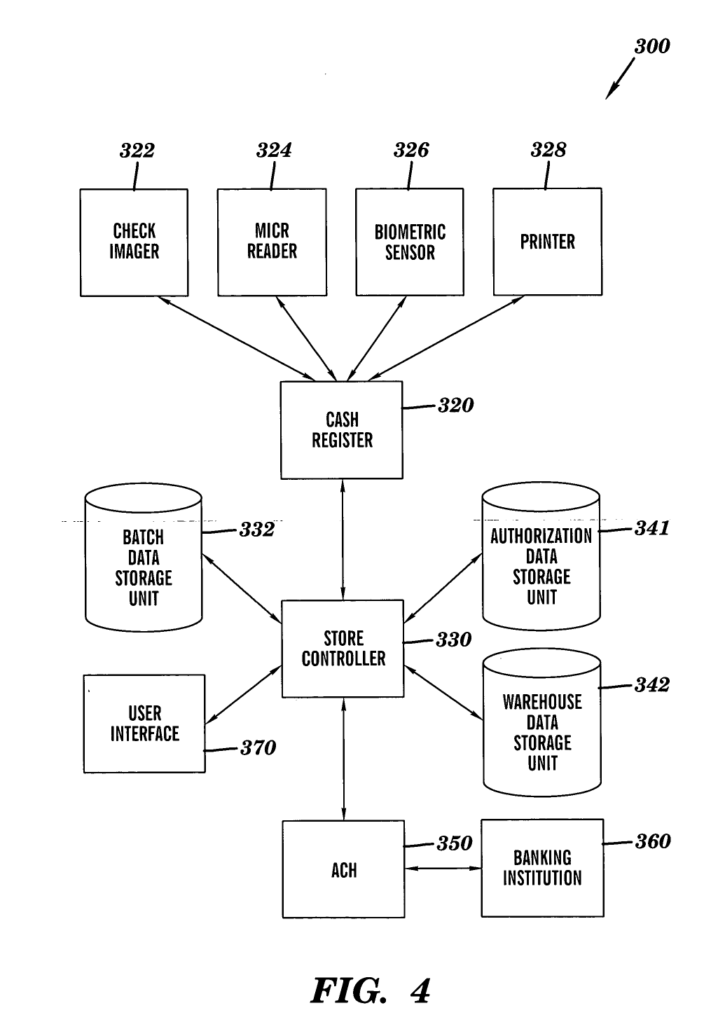

FIG. 4 illustrates a system 300 for on-line or real-time check processing of a check using a blank check at a point-of-sale. In this illustrated system, system 300 generally includes a point-of-sale terminal or cash register 320 which is connected to a check imager 322, a MICR (magnetic ink character recognition) reader 324, a biometric sensor 326, and a printer 328.

Cash register 220 is also operably connected to a store controller 330. Store controller may also be operably connected to a batch data storage unit 332, an authorization data storage unit 341, a warehouse data storage unit 342, a user interface 370, and an ACH 350 which is operably connected to a banking institution 360. As noted above, it will be appreciated that instead of an ACH, the central controller may be operably connectable to the Federal Reserve, shared bank network, a bank, credit card network, or other suitable means for settlement.

In this illustrated embodiment, biometric sensor 326 is operable to obtaining biometric information from the customer. As noted above, the biometric sensor may be a signature capture device for obtaining an image of the handwriting signature of the customer. Biometric sensor 326 may also include, for example, a fingerprint scanner for capturing an electronic information regarding a user's fingerprint, a retina or iris scanner for capturing electronic information regarding the blood vessel patterns of the retina and the pattern of flecks on the iris, a video or digital camera for capturing electronic information regarding the face of the customer, a microphone for capturing a voice print or sample of the customer, or a number pad or keyboard pad for obtaining the password of the customer along with the rate of typing and intervals between letters. By capturing an image of the blank check and biometric information, two items of separate information may be stored in the warehouse data storage unit and allow archival and retrieval for use in, for example, proving or collecting, payment in the case where the check was drawn on an account with insufficient funds or where the customer tendered the check fraudulently. In addition, the biometric information may be used for identification purposes as well in an authorization process and compared with data in an authorization data storage unit. In addition, it will be appreciated that other biometric sensors may be employed in the methods and systems of the present invention for obtaining other biometric information or other personal information particular to the customer.

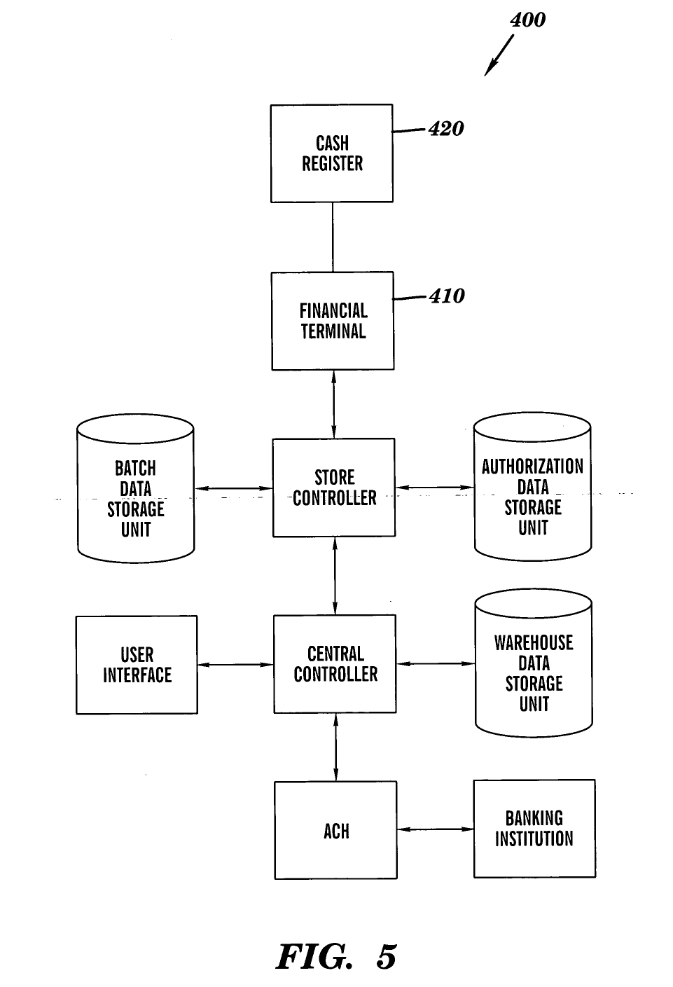

FIG. 5 illustrates a system 400 for processing a check using a blank check at a point-of-sale. In this illustrated system, a financial terminal 410 is provided which is connectable to a cash register 420, such as a preexisting cash register with limited functions, and to a store controller 430 via a communications network. The financial terminal 410 may be integral with or operably connectable to a biometric sensor, an image capture device, a MICR reader, a printer, or combinations of two or more of such devices. Such a setup desirably reduces the sales clerk or the customer's handling of the paper check as described below.

A check processing process with a blank check using the system shown in FIG. 5 includes, the customer's order initially being subtotaled on thee cash register. If the customer indicates that he or she will be paying by check, the sales clerk may indicate on the cash register that payment is by check, e.g., presses a button or enter the amount of the check payment into the cash register or financial terminal, or the customer may press an appropriate button on the financial terminal.

The cash register may then prompt the sales clerk to request a blank check from the customer. As described above, the customer need not fill in the amount of the transaction, the payee, or sign or date the check. The sales clerk then inserts the customer's blank check in the image capture device, the MICR reader, and the printer device. Alternatively, the customer may be prompted, e.g., instructed by the sales clerk or instructed by a display on the financial terminal to insert a blank check into a combination image capture device, MICR reader, and printer device.

After insertion of the blank check, the check imager then optically scans the face of the check, the MICR reader reads the MICR routing, account, and check number from the MICR line on the bottom of the check, and the printer franks, prints “VOID”, the transaction amount, transaction date, and store/terminal location, etc., on the front of the check. The financial terminal may display the ACH required or other terms and conditions, and prompt the customer to sign the signature capture device using a stylus.

Thereafter, the financial terminal transfers the electronic image of the face of the blank check, the biometric information, the transaction information (transaction amount, checking account information, any customer identification, etc.) to the store controller for storage in the batch storage unit and subsequent processing as described above.

The cash register, store controller, and the central controller may include, for instance, a processor, such as a processor or computing unit with Microsoft WINDOWS as the operating system, and based on the Intel PC architecture. The store controller and the central controller may also include a suitable LINUX, NT Workstation, or VOS controller. In addition, the various devices, e.g., check imager, MICR reader, signature capture device, may be operable to initially store the respective electronic image of the face of the blank check, MICR code, and biometric information, or transfer to the store controller without storing to the cash register or the financial terminal.

Other features of the present system may include the customer inserting a blank check into a combination check imager, MICR reader, and printer device prior to the sales clerk totaling the various items to be purchased. In addition, the MICR line may be used as the customer identification information for preauthorizing the tendering of payment by check by the customer. Further, the blank check may remain in the combination check imager, MICR reader, and printer device during preauthorizing, totaling of the sale, capturing an image of the face of the blank check, capturing biometric information, and voiding of the check.

Still other features of the various described systems may include allowing the customer to obtain cash back from the retailer, e.g., the transaction amount is the sales amount plus the amount of cash to be provided to the customer and any applicable cashback service fees. The franking of the blank check may be carried out by the sales clerk with a stamp and inkpad where, for example, a printer is not available. In addition, each transaction and image data and/or check posting transaction request may be sent directly from the cash register or financial terminal via a communications network to the warehouse data storage unit, e.g., in addition to or bypassing the store controller, or where the retail store is not provided with a store controller. Further, each check posting transaction request may be sent in real-time directly from the cash register or financial terminal via a communications network to an ACH and/or as well as to the central controller. The storage of the various data may be in a compressed file format.

From the present description, it will be appreciated that one or more of the various aspects of the check imager, MICR reader, biometric sensors, printer, cash register, financial terminal, store controller, and central controller may be operably combined in one or more devices in accordance with the present invention. The various described methods for processing a check using a blank check may utilize a combination check imager and MICR reader, or a financial terminal far use with preexisting cash registers may be provided with a biometric sensor as well as a combination check imager, MICR reader, and printer. The check imagers may include an optical read head suitably sized for scanning generally the entire surface of the front of the blank check upon the check being passed by the optical read head, and/or suitably sized, e.g., less than the length or width of a check, where the optical read head is operably moved over generally the entire surface area of the face of the blank check. Suitable devices having an optical scanner, a MICR reader, and/or a printer are disclosed in U.S. Pat. No. 5,832,463 issued to Funk, U.S. Pat. No. 5,053,607 issued to Carlson et al., U.S. Pat. No. 6,164,528 issued to Hills et al., and U.S. Pat. No. 6,257,783 to Hanaoka et al., the entire subject matter of these patents being incorporated herein by reference.

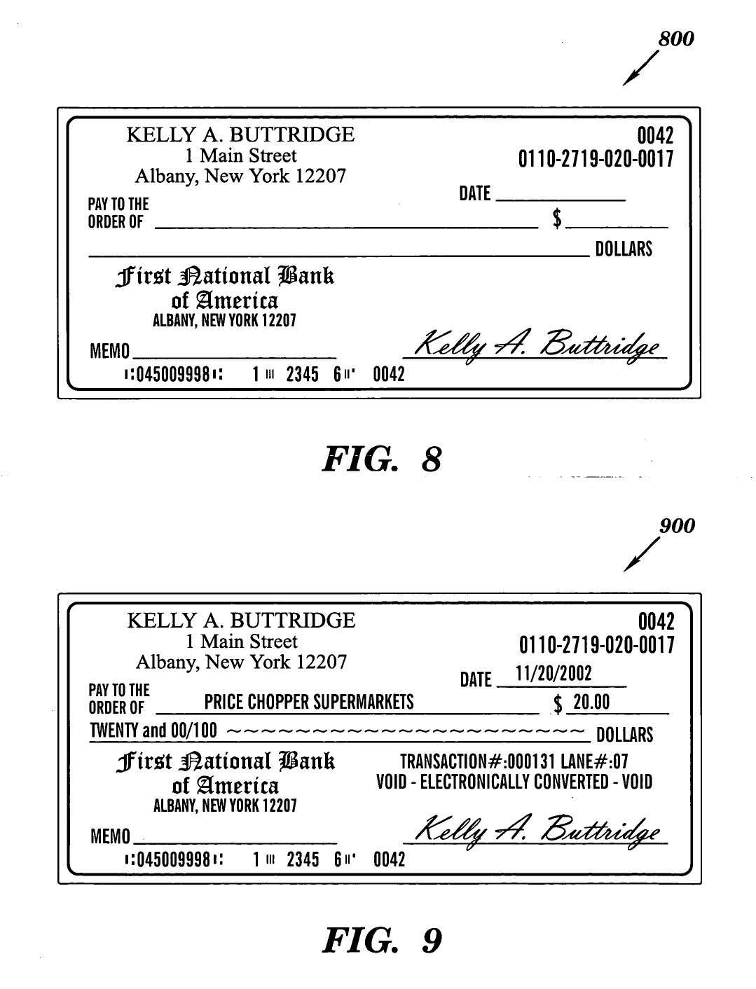

FIG. 6 illustrates one embodiment of a system 610 in accordance with the present invention which uses, for example, a partially completed check 800 (FIG. 8) having at least a customer's, an owner's or a payor's signature thereon, (e.g., the payor need not write out any other information on the check, and thus need only sign the check).

In this exemplary system, system 610 generally includes a point-of-sale terminal or cash register 620 which is connected to a combination MICR (magnetic ink character recognition) reader, printer, and check imager generally designated as reference number 622. A suitable combination MICR reader, printer, and check imager is disclosed in U.S. Pat. No. 6,257,783 to Hanaoka et al., the entire subject matter of which is incorporated herein by reference.

Cash register 620 is also operably connected to a local computing unit or store controller 630 which may also be operably connected to a plurality of cash registers (only one of which is shown in FIG. 6), each of which may be connected to a respective combination MICR reader, printer, and check imager, and may be located at a respective one of a plurality of checkout lanes via, for example communications networks. Central controller 640 may also be connected to a warehouse data storage unit 642, an authorization data storage unit 641, and to an automated clearing house (ACH) 650 which in turn may be operably connectable to one or more banking institutions 660 (only one of which is shown in FIG. 6). It will be appreciated that instead of an ACH, the central controller may be operably connectable to the Federal Reserve, shared bank network, a bank, credit card network, or other suitable means for settlement. The information stored in the warehouse data storage unit, maybe accessible via a settlement user interface 670.

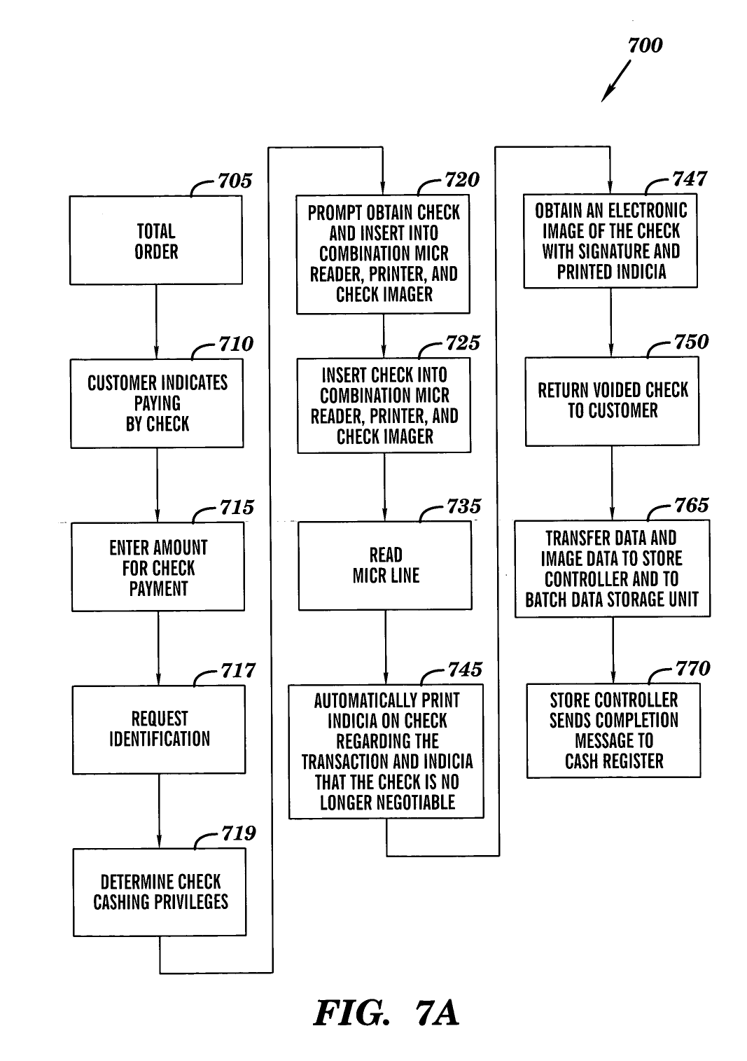

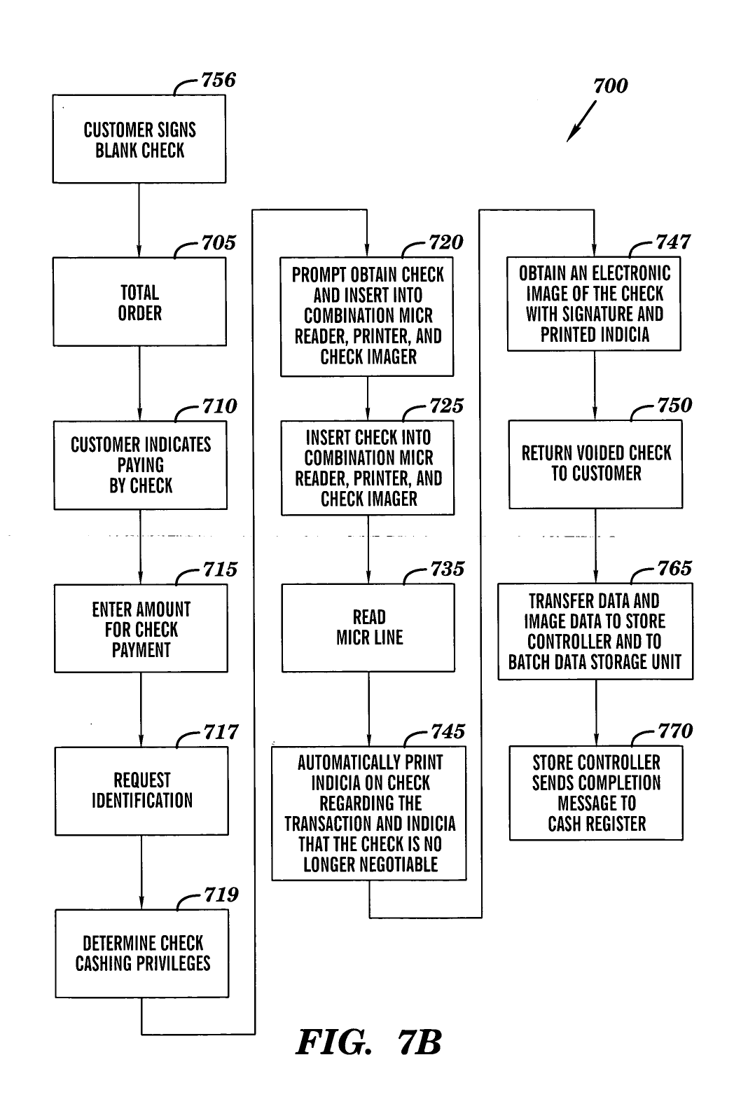

FIG. 7 illustrates a flowchart of one embodiment of a check processing process 700 using, for examples, a partially completed check having at least a customer's, an owner's or a payor's signature at a point-of-sale using the system shown in FIG. 6.

Initially, at 705, the customer's order is totaled on the cash register. If the customer indicates that he or she will be paying by check, at 710, the sales clerk enters the amount of the check payment into the cash register at 715. Alternatively, the sales clerk may be required to press a button on the cash register to indicate that payment is by check.

The clerk may request identification, at 717, such as request to see the customer's driver license or a store card issued to the customer. At 719, authorization of check cashing privileges for the customer is determined. For example, authorization may be determined by comparing the driving license with the check to confirm the same name on both the license and on the check, or by scanning the store card to display the name of the cardholder on a display and comparing the displayed name with the name on the check. In addition, the store card may be used to access the authorization data storage unit to determine whether the customer has check cashing privileges.

If check cashing privileges is authorized, the cash register terminal prompts, at 720, the sales clerk to obtain the check from the customer, for example, partially completed check 800 (FIG. 8) having the customer's signature thereon (e.g., the customer need not fill in the amount of the transaction, the payee, or date the check). At 725, the check is inserted into the combination MICR reader, printer, and check imager 622 (FIG. 6).

At 735, the check is read by the MICR reader for obtaining the routing number, account number, and check number from the MICR line at the bottom of the check.

The printer (under control of the cash register or a processor), at 745, may then automatically print indicia on the front of the check, for example, a numerical transaction amount, a written out transaction amount, the payee, the transaction date, the store location, ACH required or other required terms and conditions, and/or other information. The printer may also print on the front of the check indicia indicating that the check, e.g., the physical check or paper check, is no longer negotiable. For examples, the printer may print the word “VOID, the phrase “ELECTRONICALLY CONVERTED”, or “NON NEGOTIATABLE.” This prevents the use of, for example, the physical check or paper check from being deposited for settlement. FIG. 9 illustrates a check 900 having indicia including a numerical transaction amount, a written out transaction amount, the payee, the transaction date, the store location, the word “VOID, and the phrase “ELECTRONICALLY CONVERTED” printed on the front of the check.

The check imager then scans and obtains, at 747, an electronic image of a face of the check which includes the customer's signature and the automatically printed indicia.

Thereafter, the sales clerk can return the voided physical check to the customer at 750.

At 765, the cash register then transfers the transaction data and image data (e.g., an electronic image of the check having the customer's handwritten signature and the printed indicia), the customer identification, the transaction amount, the transaction date and time, the check number, the MICRR code, the store location, the lane location identifier, and/or the clerk identifier via store controller 630 (FIG. 6) for storage.

After the transaction data and image data are transferred and stored in the data storage units, e.g., on the hard drive of the store controller and/or central controller, the store controller sends a completion message to the cash register indicating the end of the transaction, at 770. Alternatively, the cash register may send the transaction data and image data to the store controller and the store controller then generates and forwards the required data to the batch data storage unit.

Thereafter, the stored data or portions thereof may be suitably used for settlement. For example, the stored data or portions thereof may be used to generate an electronic check posting transaction request. The stored data or portions thereof or electronic check posting transaction requests may be forwarded for settlement either individually or as a batch.

Where electronic settlement of the check does not result, e.g., where there is insufficient funds, the electronic image of the check having indicia that the physical check is no longer negotiable or a printed copy thereof may be used for settlement.

In another aspect of the present invention, a blank check may be used in the process illustrated in FIG. 7 and the system illustrated in FIG. 6. In this aspect, the check may be automatically printed at the point-of-sale with indicia regarding the transaction and indicating that the physical check is no longer negotiable, and then imaged. It will also be appreciated that the present invention may use a completely filled out check with is automatically printed with indicia indicating that the check, e.g., the physical check, is no longer negotiable.

It will be appreciated that the systems and processes described above in connection with FIGS. 1-5 may be suitably employed without the signature capture device or the biometric sensor to enable check processing using a blank check or a partially completed check having at least the customer's signature thereon which is automatically printed with indicia indicating that the physical check is no longer negotiable in accordance with the present invention.

From the present description, it will also be appreciated by those skilled in the art that various combinations of the various aspects of the disclosed methods for check processing, e.g., preauthorization, check authorization, on-line generation of check posting transaction request, etc. may be combined in further systems and methods using a partially completed check in accordance with the present invention. In addition, an authorization data storage unit or negative file may be connected to the store controller. Further, while it is desirable that the user not complete or fully write out the check, it will be appreciated that the above-described methods for processing a check using a partially completed check with at least a payor's, signature would be operable even if a customer in a checkout line wrote out one or more additional items on the partially completed check.

In addition, one or more stores may share a controller such as a store controller. Such a shared to controller may be suitable where a store's primary (or normal) store controller experiences a hardware failure (e.g., where a hard drive or a mother board dies). The shared controller may also reside in a different physical location than the store where the transaction or point-of-sale is conducted.

Thus, while various embodiments of the present invention have been illustrated and described, it will be appreciated to those skilled in the art that many changes and modifications may be made thereunto without departing from the spirit and scope of the invention.

1. A method for enabling electronic check processing of a transaction at a pointof-sale, the method comprising:
receiving a transaction amount;
receiving checking account information from a physical check; and receiving an electronic image of the physical check with printed first indicia that the physical check is no longer negotiable.

2. The method of claim 1 wherein the printed first indicia comprises a printed word “VOID”.

3. The method of claim 1 wherein the printed first indicia comprises a printed phrase “ELECTRONICALLY CONVERTED”.

4. The method of claim 1 wherein the receiving checking account information comprises receiving checking account information from the physical check being partially completed by a payor.

5. The method of claim 1 wherein the receiving checking account information comprises receiving checking account information from the physical check having only a payor's signature thereon.

6. The method of claim 1 wherein the receiving checking account information comprises receiving checking account information from a blank physical check.

7. The method of claim 1 further comprising automatically printing the printed first indicia on the physical check indicating that the physical check is no longer negotiable.

8. The method of claim 7 further comprising automatically printing second indicia on the physical check regarding the transaction at the point-of-sale, and the receiving the electronic image comprises receiving the electronic image of the physical check with the printed second indicia regarding the transaction.

9. The method of claim 8 wherein the automatically printing the second printed indicia comprises automatically printing a payee, a date, a numerical amount of the transaction, and a written amount of the transaction.

10. The method of claim 1 further comprising determining whether the payor of the physical check has check cashing privileges.

11. The method of claim 1 further comprising returning the physical check to the payor.

12. The method of claim 1 further comprising storing a plurality of transaction amounts, a plurality of checking account information, and a plurality of electronic images, and transferring as a batch the plurality of transaction amounts, the plurality of checking account information, and plurality of electronic images to a warehouse data storage unit.

13. A method for enabling electronic check processing of a transaction at a point of-sale, the method comprising:
receiving a transaction amount;
receiving a physical check having only a payor's signature;
receiving checking account information from the physical check; automatically printing on the physical check a payee, a date, and an amount of the transaction;
automatically printing indicia on the physical check indicating that the physical check is no longer negotiable;
receiving an electronic image of the physical check with the payor's signature, the payee, the date, the amount of the transaction, and the indicia that the physical check is no longer negotiable;
and returning the physical check to the payor.

14. A method for electronic check processing, the method comprising:
receiving a transaction amount;
receiving checking account information from a physical check;
receiving an electronic image of the physical check with printed first indicia that the physical check is no longer negotiable;
and forwarding the transaction amount and the checking account information for settlement.

15. The method of claim 14 wherein the printed first indicia comprises a printed word “VOID”.

16. The method of claim 14 wherein the printed first indicia comprises a printed phrase “ELECTRONICALLY CONVERTED”.

17. The method of claim 14 wherein the receiving checking account information comprises receiving checking account information from the physical check being partially completed by a payor.

18. The method of claim 14 wherein the receiving checking account information comprises receiving checking account information from the physical check having only a payor's signature thereon.

19. The method of claim 14 wherein the receiving checking account information comprises receiving checking account information from a blank physical check.

20. The method of claim 14 further comprising automatically printing the printed first indicia on the physical check indicating that the physical check is no longer negotiable.

21. The method of claim 20 further comprising automatically printing second indicia on the physical check regarding the transaction at the point-of-sale, and the receiving the electronic image comprises receiving the electronic image of the physical check with the printed second indicia regarding the transaction.

22. The method of claim 21 wherein the automatically printing the second printed indicia comprises automatically printing a payee, a date, a numerical amount of the transaction, and a written amount of the transaction.

23. The method of claim 14 further comprising determining whether the payor of the physical check has check cashing privileges.

24. The method of claim 14 further comprising returning the physical check to the payor.

25. The method of claim 14 further comprising storing a plurality of transaction amounts, a plurality of checking account information, and a plurality of electronic images, and transferring as a batch the plurality of transaction amounts, the plurality of checking account information, and plurality of electronic images to a warehouse data storage unit.

26. The method of claim 14 wherein the forwarding comprises forwarding a plurality of transaction amounts and a plurality of checking account information as a batch for settlement.

27. The method of claim 14 wherein the forwarding comprises generating an electronic check posting transaction request from the transaction amount and the checking account information, and forwarding the electronic check posting transaction request for settlement.

28. The method of claim 14 further comprising storing electronic information regarding settlement of the check-posting transaction request.

29. A method for electronic check processing, the method comprising: receiving a transaction amount;
receiving a physical check having only a payor's signature;
receiving checking account information from the physical check;
automatically printing on the physical check a payee, a date, and an amount of the transaction;
automatically printing indicia on the physical check indicating that the physical check is no longer negotiable;
receiving an electronic image of the physical check with the payor's signature, the payee, the date, the amount of the transaction, and the indicia that the physical check is no longer negotiable;
returning the physical check to the payor; and
forwarding the transaction amount and the checking account information for settlement.

30. A method for warehousing information relating to check transactions, the method comprising:
storing in at least one data storage unit a transaction amount, checking account information from a physical check, and an electronic image of the physical check with printed first indicia that the physical check is no longer negotiable.

31. The method of claim 30 wherein the printed first indicia comprises a printed word “VOID”.

32. The method of claim 30 wherein the printed first indicia comprises a printed phrase “ELECTRONICALLY CONVERTED”.

33. The method of claim 30 wherein the electronic image comprises an electronic image of the physical check having the payor's signature and second indicia automatically printed on the physical check at the point-of-sale regarding the transaction.

34. The method of claim 33 wherein the second indicia automatically printed on the physical check comprises a payee, a date, a numerical amount of the transaction, and a written amount of the transaction.

35. A method for electronic check processing, the method comprising: forwarding an electronic image of a physical check with printed first indicia that the physical check is no longer negotiable for settlement.

36. The method of claims 35 wherein the forwarding comprises generating a printed image of the electronic image, and forwarding the printed image for settlement.

37. A system for enabling electronic check processing at a point-of-sale, said system comprising:
a processor for receiving a transaction amount, checking account information from a physical check, and an electronic image of the physical check having first indicia indicating that the physical check is no longer negotiable; and
said processor being operable to at least one of a) transfer the transaction amount, the checking account information and the electronic image to a data storage unit, and b) forward the transaction amount and the checking account information for settlement.

38. The system of claim 37 wherein the electronic image comprises the physical check having the payor's signature and second indicia automatically printed on the physical check at the point-of-sale regarding the transaction.

39. The system of claim 37 further comprising a MICR reader for obtaining the checking account information from the physical check, a printer for printing the indicia on the physical check, and a scanner for obtaining the electronic image of the physical check.

40. The system of claim 37 wherein said processor is operable to forward the transaction amount and the checking account information over a communications network for settlement.

41. A system for enabling electronic check processing at a point-of-sale, said system comprising:
a cash register;
a MICR reader;.
a printer;
a scanner; and
a processor operable to receive a transaction amount from said cash register, receive checking account information from said MICR reader regarding a physical check, print first indicia on the physical check with the printer indicating that the physical check is no longer negotiable, and receive an electronic image from the scanner of the physical check having the printed indicia.

42. The system of claim 41 wherein said processor is operable to print second indicia on the physical check comprising printing a payee, a date, and an amount of the transaction.

43. The system of claim 41 wherein said processor is operable to transfer the transaction amount, the checking account information, and the electronic image to a data storage unit.

44. The system of claim 41 wherein said processor is operable to generate a check posting transaction request from the transaction amount and the checking account information.

45. The system of claim 41 wherein said processor is operable to forward the transaction amount and the checking account information over a communications network for settlement.

46. At least one program storage device readable by a machine, tangibly embodying at least one program of instructions executable by the machine to perform a method for enabling check processing at a point-of-sale, the method comprising:
receiving a transaction amount;
receiving checking account information from a physical check; automatically printing indicia on the physical check indicating that the physical check is no longer negotiable; and
receiving an electronic image of the physical check having the printed

47. An article of manufacture comprising:
at least one computer usable medium having computer readable program code means embodied therein for use in check processing, the computer readable program code means in said article of manufacture comprising:
computer readable program code means for causing a computer to receive a transaction amount;
computer readable program code means for causing a computer to receive checking account information from a physical check;
computer readable program code means for causing a computer to automatically, print indicia on the physical check indicating that the physical check is no longer negotiable;
computer readable program code means for causing a computer to receive an electronic image of the physical check with the indicia; and
computer readable program code means for causing a computer to at least one of a) transfer the transaction amount, the checking account information and the electronic image to a data storage unit, and b) forward the transaction amount and the checking account information for settlement.
